(19) United States
(12) Patent Application Publication
(10) Pub. No.: US 2012/0158549 A1
(43) Pub. Date: Jun. 21, 2012

(54) Computerized Methods To Facilitate Selective Communications Between And Among Motor Vehicle Purchasers, Dealers, And Salespeople

(75) Inventor: Charles H. Dapoz, Manhattan Beach, CA (US)

(73) Assignee: ALIGN RESEARCH LLC, Manhattan Beach, CA (US)

(21) Appl. No.: 13/324,873

(22) Filed: Dec. 13, 2011

Related U.S. Application Data
(60) Provisional application No. 61/423,555, filed on Dec. 15, 2010.

(51) Int. Cl. G06Q 30/00

(52) U.S. Cl. 705/27.1

(57) ABSTRACT

An electronic business site to facilitate selective communications between and among motor vehicle purchasers, dealers, and salespeople. Informational profiles of dealers and salespeople, are selectively accessed, reviewed, and compared by a potential purchaser of a motor vehicle. The profiles for the dealer and salespeople include respective textual, or visual, or audio-visual information about them. The profiles are cross-linked, so at least some of said information from the dealer profile is displayed on the salesperson profile when the salesperson's profile is accessed by a potential purchaser. In the event the potential purchaser finds a suitable dealer and/or salesperson, the consumer can initiate communications with either of them, in the form of a request for contact or a price quote, in furtherance of the goal of purchasing a motor vehicle.

### PRIORITY CLAIM

Pursuant to the provisions of 35 U.S.C. §119(e)(1), Applicant claims the priority of U.S. Provisional Patent Application Ser. No. 61/423,555, filed Dec. 15, 2010.

### BACKGROUND OF THE INVENTION

1. Field of the Invention

The invention relates generally to computerized methods to facilitate the purchase and sale of motor vehicles. More particularly, the invention pertains to the establishment, maintenance, and use of an electronic business site and methods of using same, in which informational profiles of vendors of motor vehicles, including dealers and salespeople, are selectively accessed, reviewed, and compared by a potential purchaser of a motor vehicle. In the event the potential purchaser finds a suitable dealer and/or salesperson, the purchaser can initiate communications with them, in furtherance of the goal of purchasing a motor vehicle.

2. Description of the Prior Art

The oldest and most common manner in which motor vehicles are purchased is in person, at a dealership or a used car lot. The dealership or lot maintains an inventory of vehicles on site, for the potential purchaser to view and examine, and in some cases, take for a test drive. However, before that happens, the purchaser, upon entering upon the dealer's premises is met by a salesperson. In all likelihood, this is not a person who has been selected or chosen by the purchaser; he or she is just the next salesperson in line to greet the public.

The potential purchaser has no information about the salesperson who meets them, as he or she is a total stranger. There is naturally a certain amount of distrust and skepticism associated with any automobile salesperson, and the high-pressure sales tactics commonly employed by the sales force do nothing to mitigate these negative feelings among the purchasing public. In addition, after initial model selection and general price discussions with the salesperson, purchasers often get handed over to a sales manager, or closer, for final negotiations. These negotiations are seldom a pleasant experience for potential purchasers.

Although the above-discussed dealership or used car lot sales experience is still very typical, many potential purchasers have increasingly turned to the world wide web as a precursor step to purchasing a motor vehicle. Internet searches can reveal many facts about particular brands and models. The manufacturers' Internet web sites show photos, videos, specifications, and comparative information about the variety of models offered. Some manufacturers' web sites allow potential purchasers to “build” their hypothetical dream car, outfitted in a selected color, and having all of the features and accessories that are chosen. A list price for the dream car may also be available to the potential purchaser.

Independent reviews of past or current models are also available on the Internet, so the potential purchaser can gain the opinion of another person, preferably an expert, about the virtues and problem areas associated with particular brands and models. By considering the opinions of several different reviewers, the potential purchaser can develop his or her own conclusions about the model under consideration, even before taking a test drive.

Motor vehicle pricing information is also available on the Internet, including manufacturer's suggested retail prices, dealer invoice prices, transaction prices for specific geographic areas, discounts and incentives, and subvented financing and leases. Detailed pricing for special models, options, and accessories is also readily available, so the interested shopper can head into price negotiations relatively well informed about how much dealer profit leeway exists for the sale of a particular model.

Many of those who conduct automotive research on the Internet also prefer to solicit actual price quotes from dealers using the Internet. U.S. Pat. No. 6,282,517, issued to Wolfe et al., is exemplary. The '517 Patent discloses a method and apparatus for Real Time Communication Of Purchase Requests. In this system, a potential buyer submits a purchase request over a computer network, interconnected to a data center. The purchase request includes product identification data and information about the potential buyer's location. The data center determines at least one dealer to receive the purchase request, and communicates the purchase request information to that dealer. The dealer, or multiple dealers in a given case, then contact the potential buyer. This approach is driven primarily by product information about the make and model of a particular motor vehicle and by the location of the potential purchaser, not necessarily by selections made by the potential purchaser about a particular dealer or a specific salesperson with whom to deal.

Automobile dealers also have Internet web sites, which are calculated to generate sales leads. These leads correspond to information about and inquiries submitted by, a potential purchaser. In this type of transaction, the potential purchaser has already selected a brand, a model, and a dealer. In order to receive a price quotation for the selected model, the purchaser must complete a form on-line, usually providing name, address, phone number, e-mail address, and other personal information. A dealership representative then contacts the potential purchaser, and with further communications, negotiations for the purchase of a vehicle may ensue.

### SUMMARY OF THE INVENTION

The present invention provides computerized methods and systems to facilitate selective communications between and among potential purchasers, dealers, and salespeople. One of the significant differences between the present method, and those employed in the prior art, is that the automobile purchasing process is initially driven by the potential purchaser's selection of one or more particular dealers or salespersons with whom to communicate and deal.

This objective is technically accomplished by establishing and maintaining a profile database including at least one dealer profile and at least one salesperson profile accessible for viewing at an Internet website. Preferably, to offer the greatest number and variety of options and selection choices to the potential purchaser, or web page user, the profile database will include a plurality of dealer profiles and a plurality of salesperson profiles.

Each dealer profile includes textual, or visual, or audio-visual information about a particular dealer. Each salesperson profile includes textual, or visual, or audio-visual information about a particular salesperson. The dealer and salesperson profiles are functionally cross-linked, so at least some of the information from the dealer profile is displayed on the salesperson profile when the salesperson profile is accessed over the Internet by a potential purchaser. Preferably, the cross-linking function is also complementary, so at least some of the content from at least one salesperson's profile, such as his or her name and a photograph, is displayed on the dealer's profile when the dealer's profile is accessed over the Internet by a potential purchaser.

The profile database is under the exclusive control of a dealer/administrator. Such control includes edit and manage functions over additions or changes to the content of the dealer profile and the salesperson profile.

Another feature of the database is that the salesperson profile is under the conditional control of that salesperson. Thus, providing certain conditions are satisfied, the salesperson made the subject of his or her profile would enjoy edit and mange functions over additions or changes to the content of their profile. However, these edit and manage functions are subordinate to the exclusive control of the dealer/administrator, so that proposed additions or changes to the content of a salesperson profile must be approved or permitted by the dealer/administrator before edit and manage functions for the salesperson profile are enabled.

Lastly, the content of the dealer profiles and the salesman profiles may be viewed on a publicly accessible electronic business site, preferably on the Internet. In that manner, a potential purchaser can selectively access, review, and compare one or more profiles of dealers and one or more profiles of salespersons, thereby making informed, selective decisions about whom the potential purchaser wants to contact and engage, for further communications, negotiations, and contractual arrangements.

To that end, the dealer profiles will typically include the dealer's name, street address, telephone number, a link to the dealer's web site, the automobile brands carried, background information about the dealer, photos of the premises, audio-visual information about the dealer, customer testimonials, and direct links to the dealer requesting a contact or a price quote.

The salesperson profiles are similar to the dealer profiles, but they also contain further personal information and interests associated solely with a particular salesperson. Thus, a typical salesperson profile would contain his or her dealer's name, street address, and phone number, a link to the dealer's web site, the brands of automobile the salesperson sells, personal or biographical information about the salesperson's family background, hometown, educational history, work experience, military experience, and personal interests, such as hobbies, sports, and outside work activities. The salesperson profile would also typically include photos as well as an audio-visual presentation where the salesperson would introduce him or herself and provide a synopsis and narrative about themselves, their interests, and life experiences. The salesperson profile may also include customer testimonials in text or audio-visual form, about past transactions with the particular salesperson. A direct link for an e-mail address or a telephone number would also be provided, so the potential purchaser can make a direct contact with the salesperson or request a quote for one or more motor vehicles.

Two business models are disclosed, one where the subject website is owned and operated by a website service provider, and the other where the subject website is owned and operated by a dealer association or an auto mall, involving a number of different dealers typically located in a particular geographical region or location.

These and other features, aspects, and characteristics of the invention will be more apparent from the drawings and the detailed description of the preferred embodiment, to follow.

### BRIEF DESCRIPTION OF THE DRAWINGS

FIG. 1 is a pictorial diagram of the components and participants of electronic business sites, each business model being interconnected to a network such as the world wide web, and being independently accessible by one or more purchaser web clients;

FIG. 2 is a functional block diagram showing the roles, functions and controls of the dealer/administrator and the salesperson, in creating and maintaining information and data in a dealer profile and a salesperson profile that are functionally cross-linked;

FIG. 3 is a functional block diagram of a variant circumstance, where at least two dealerships are under common ownership or control, both dealer profiles being cross-linked to the same salesperson, who has two different salesperson profiles;

FIG. 4 is a functional block diagram of a variant circumstance, where a single dealer/administrator has edit and manage controls over a plurality of dealer profiles;

FIG. 5 is a flow chart, showing a typical scenario of events, when a potential purchaser visits the electronic business website, and elects to review, assess, and possibly pick one or more dealers he or she finds suitable for contacting or requesting a price quote; and,

FIG. 6 is a flow chart, showing a typical scenario of events, when a potential purchaser visits the electronic business website, and elects to review, assess, and possibly pick one or more salespeople he or she finds suitable for contacting or requesting a price quote.

### DETAILED DESCRIPTION OF THE PREFERRED EMBODIMENT

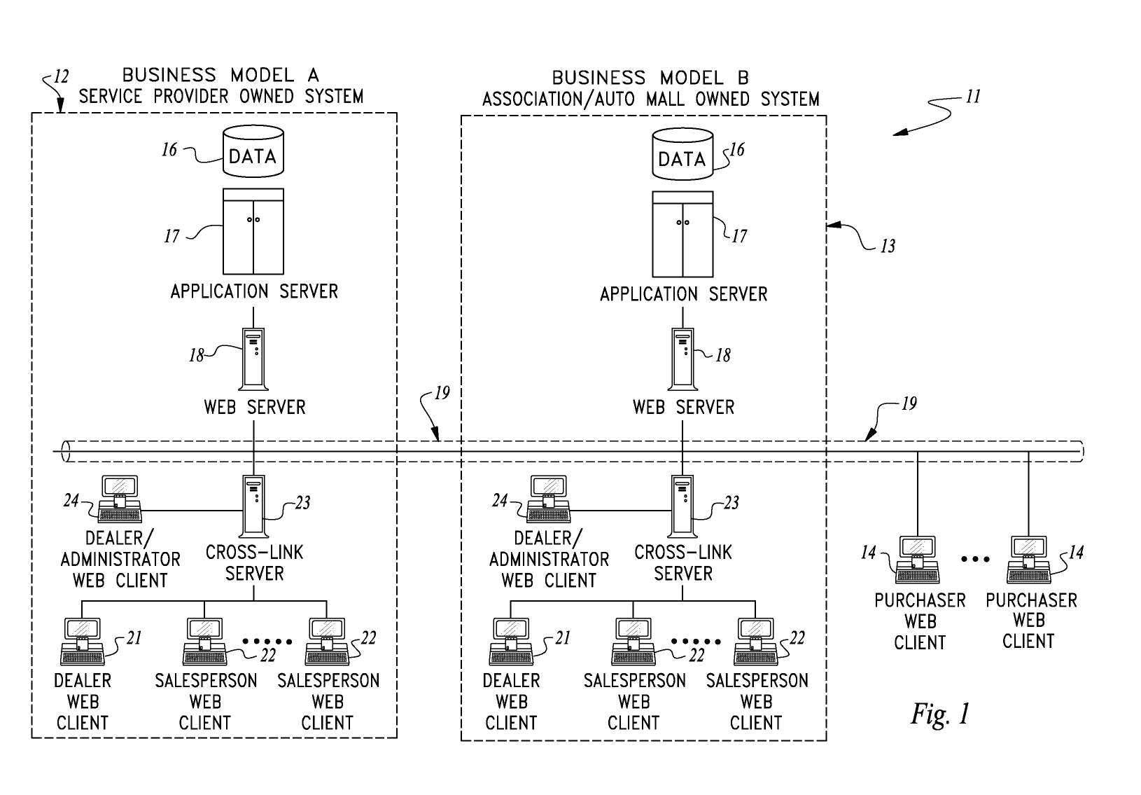

Turning now to FIG. 1, the computerized system 11, used to implement the methods of the present invention, may include a service provider owned system 12 and an association/auto mall owned system 13. As will be explained more fully below, these two systems share the same components and function in a very similar fashion, but the business model for each is different. For purposes of the following discussion, service provider owned system 12 and association/auto mall owned system 13 may be viewed as business model subsets of computerized system 11.

In the service provider owned system 12, a plurality of different automotive dealers pay a service provider a subscription fee for the service of establishing and maintaining an Internet website containing information and systems which purchaser web clients 14 can access and use. In the association/auto mall owned system 13, a group of dealers, generally in the same geographical region or congregated at the same location at an auto mall, own and maintain an Internet website for the same purpose as system 12, but the group typically pays a monthly or annual license fee for the use of the system 13 and to practice of the methods disclosed herein. For the purposes of explaining the system 11, most of the description below will focus upon the service provider owned system 12, also called Business Model A.

System 12 includes data storage 16, an application server 17, and a web server 18, functionally integrated and interconnected to a network, preferably the world wide web 19. The data storage 16 maintains electronic records for all of the information about the dealerships and the salespeople, as well as particulars for the communications and transactions between and among the various parties in the system 12. The application server 17 includes the software that establishes and maintains the various records and the website of the system 12, and routes communications and information between and among the parties. The web server 18 provides an incoming and outgoing communication interface with the web 19.

At least one dealer web client 21 and at least one salesperson web client 22 are also provided. The dealer web client 21 is typically operated by a manager or supervisor within an automobile dealership. Each salesperson web client 22 is operated by an individual salesperson who has some association with one or more automobile dealerships. Dealer web client 21 and salesperson web client 22 are functionally cross-linked through a cross-link server 23, also interconnected to the web 19. A dealer/administrator web client 24, is in communication with the cross-link server 23. The dealer/administrator web client 24 is typically operated or supervised by management in an automotive dealership, or by an owner of more than one automotive dealerships. Variations and further expansions of these relationships and arrangements will be explained below.

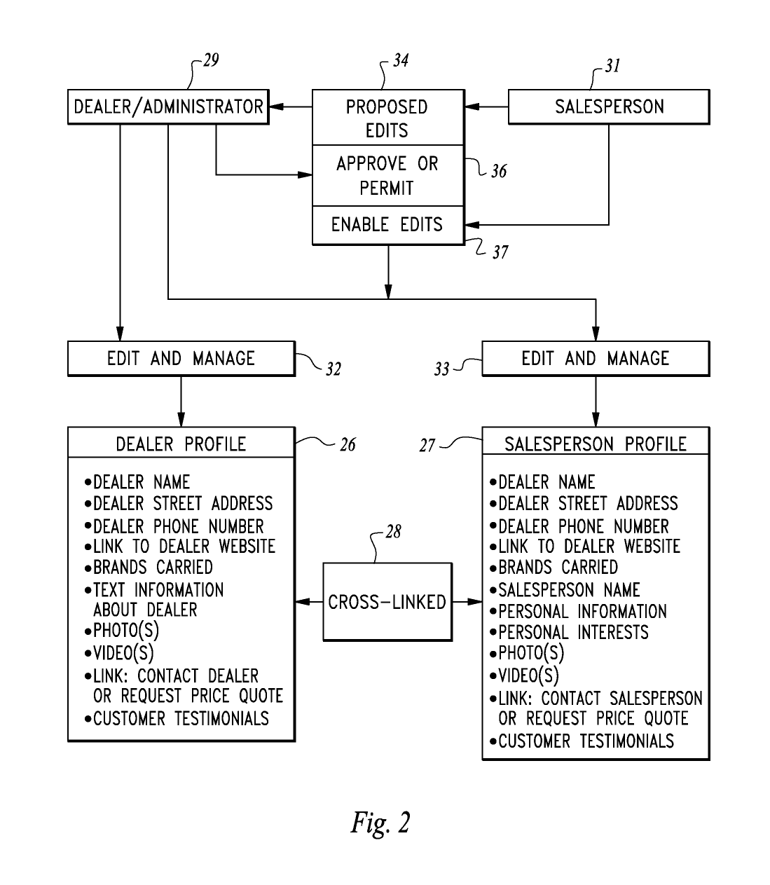

With these functional components and interrelationships within computerized system 12 in mind, a description of the creation and maintenance of a dealer profile 26 and a salesperson profile 27 will be provided. As is evident in FIG. 2, profiles 26 and 27 include textual, visual, and audio-visual content calculated to communicate to a potential purchaser, engaging and important information about a particular dealer and a particular salesperson.

For example, and not by way of limitation, a dealer profile 26 may include the dealer name, the dealer street address, the dealer phone number, a link to the dealer's website, the brands of new and/or used motor vehicles carried by the dealer, textual information about the dealer, photos of the interior and exterior of the dealership premises, photos and videos about the dealership's operations, services, and personnel, direct communication links to the dealership requesting return contact and/or price quotations for particular automobiles, and customer testimonials.

Also by way of example, a salesperson profile may include the name of the dealer the salesperson is associated with, the dealer street address, the dealer phone number, a link to the dealer's website, the brands of new and/or used motor vehicles carried by the dealer, the salesperson's name, personal information about the salesperson, personal interests of the salesperson, photos of the salesperson, videos featuring the salesperson, direct communication links to the salesperson requesting return contact and/or price quotations for particular automobiles, and customer testimonials. The personal information about the salesperson may include a biography, stating the salesperson's hometown, educational background, work experience, military service, by example. The personal interest information may include hobbies, sports, and outside activities of the salesperson.

The dealer profile 26 and the salesperson's profile 27 are cross-linked 28, so that when the salesperson's profile 27 is viewed by a potential purchaser, at least a portion of the content of the cross-linked dealer profile 26 will also be visually incorporated. Typically and preferably, the cross-linking feature will function both ways, so the dealer's profile 28 will also include at least a portion of the content of the cross-linked salesperson's profile.

FIG. 2 also includes a functional block diagram portion, depicting control and permitted communication paths for a dealer/administrator 29 and a salesperson 31. The dealer/administrator 29 has exclusive control, including capabilities directly to edit and manage 32 and to edit and manage 33, respectively, over additions or changes to the content of the dealer profile 26 and the salesperson profile 27.

The salesperson profile 27 is under the conditional control of salesperson 31. By this it is meant that capabilities to edit and manage 33 are subordinate to the exclusive control of the dealer/administrator 29. Proposed edits 34, in the form of additions or changes to the content of the salesperson profile 27, must first be approved or permitted by the dealer/administrator 29. This is effected by the salesperson 31 first submitting the proposed edits 34 to the dealer/administrator 29. After review and approval, the dealer/administrator 29 issues a command to approve or permit 36 the proposed edit 34. This command enables edits 37, so that the capabilities to edit and manage 33 the salesperson profile 27 can be exercised by the salesperson 31. It is also contemplated that a dealer/administrator 29 may issue an open command to approve or permit 36, so that not all edits a salesperson 31 wants to make must be proposed and approved. However, since the dealer/administrator 29 has exclusive control over this function, such permission may be revoked at any time. This arrangement providing for exclusive and conditional control over such profiles may be termed asymmetrical, in that control over the content of the respective profiles of the dealer and the salesperson is not equally shared or distributed.

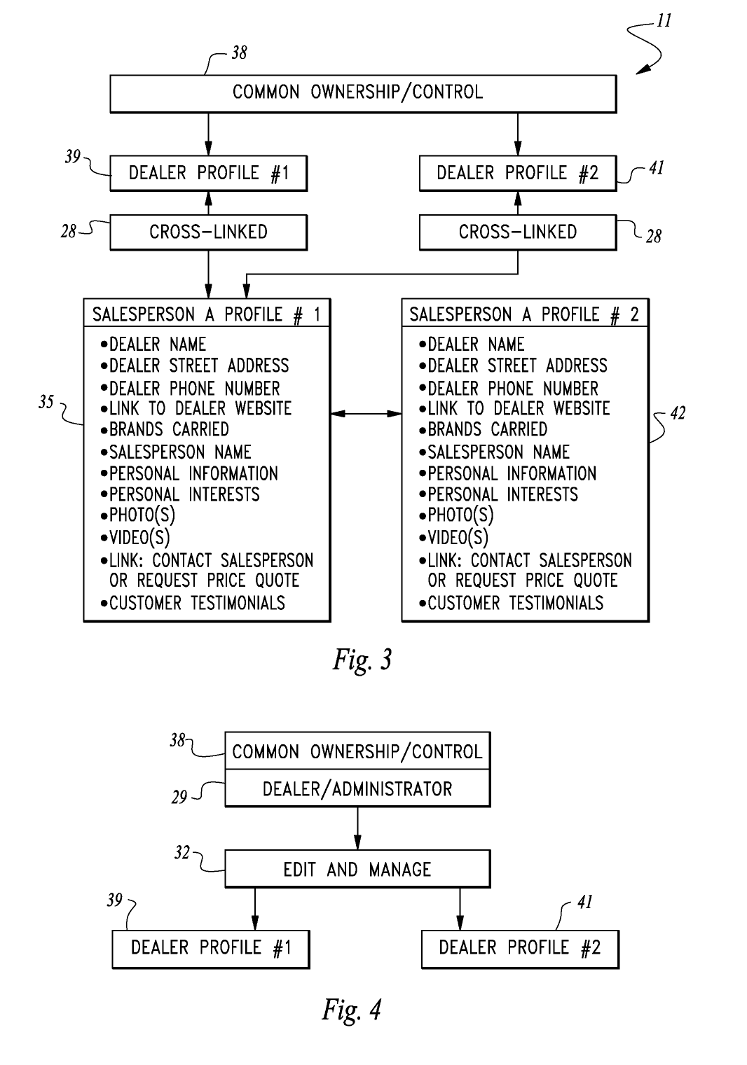

Turning now to FIG. 3, variations upon the relationships between dealers and salespersons are shown. FIG. 3 also shows a more complex arrangement for salesperson profiles, where a single salesperson has at least two different profiles. The computerized system 12 of the present invention is adapted to accommodate these relationships and database structures. Where at least two dealerships are under common ownership or control 38, the system 12 allows a first salesperson profile 35 to be cross-linked 28 to a first dealer profile 39 and a second dealer profile 41. The practical effect of this profile cross-link is that a potential purchaser could view two different dealers in salesperson A's profile, and conversely, the salesperson As profile would be present when viewing each dealer's profile.

FIG. 3 also shows that salesperson A who has a first salesperson profile 35 and a second salesperson profile 42. This would be appropriate where salesperson A is bilingual, say fluent both in English and in Spanish. All text in salesperson A's first salesperson profile 35 would be written in English, and any audio-visual presentations would be spoken in English. Similarly, all text in salesperson A's second salesperson profile 42 would be written in Spanish, and any audio-visual presentations would be spoken in Spanish. Thus, a prospective purchaser who was English speaking would choose to view and review the first salesperson profile 35. But if the prospective purchaser were Spanish speaking, they would choose to view and review the second salesperson profile 42.

FIG. 4 elaborates upon the edit and manage relationship for dealer profiles, where there is common ownership/control 38 of at least two dealerships, as depicted in FIG. 3. The system 12 is designed to accommodate a single dealer/administrator 29 having edit and manage 32 control over at least two dealer profiles. Thus, system 12 may be configured to allow single a dealer/administrator 29 to edit and manage the content of first dealer profile 39 and second dealer profile 41. As a corollary to this exclusive control over the dealer profiles, the same dealer/administrator would have exclusive control over all salesperson profiles (not shown in FIG. 4 for clarity) which are respectively cross-linked to profiles 39 and 41.

In use, the system 12 provides a website on the Internet, that is publicly accessible by potential purchasers of motor vehicles. When the potential purchaser, or website user, views the website, there are two primary search functions: search for a dealer or search for a salesperson.

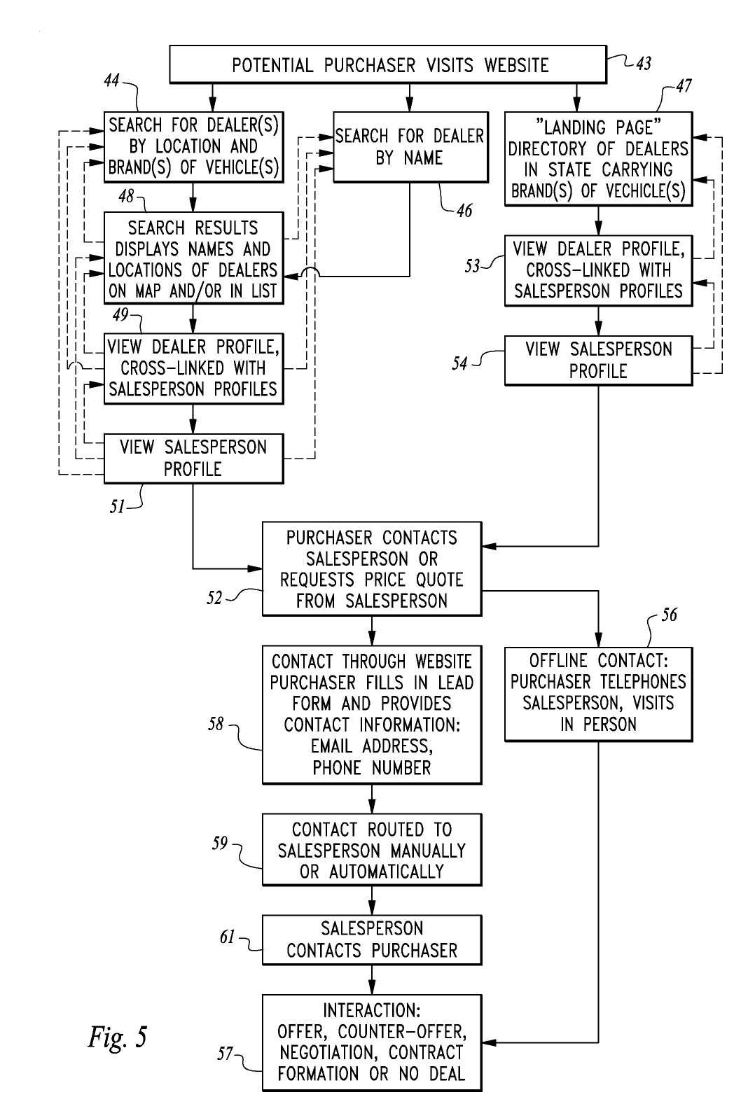

FIG. 5 represents a flow chart of the steps taken and options presented when a typical search for a dealer is made. When a user visits the website 43, three options are available: Option 44—Search for dealer(s) by location and brand(s) of vehicle(s) carried; Option 46—Search for dealer by name; and, Option 47—Directly accessing the “Landing Page”, showing for example: a directory of dealers in a state which carry brand(s) of vehicle(s); a directory of dealers in an auto mall, city, or other geographic area; a directory of dealers offering specific services, such as extended test drives or open late in the evening; or a directory of dealers offering specific types of vehicles, such as off-road trucks or electric vehicles.

In the event option 44 is chosen, the user will enter a location, typically by city, state, or ZIP code, where the sought after dealer is located. The user can also select vehicle brand(s) he or she is interested in. In step 48, the system 12 will display a web page showing the results of the search in which the names and locations of dealers are shown on a map and/or in a list. If option 46 is chosen, namely, search for dealer by name, the user will also be routed to step 48, and will be shown the same dealer name and location information. If the potential purchaser either made a mistake in his or her selection of location or brand, or simply wants to conduct a new search, the page has a return option, represented by a broken line in FIG. 5, and return to option 44.

The user selects a dealer, and in step 49, the system displays a page showing the dealer profile and any cross-linked profiles of salespeople. The user may select a salesperson profile, and go directly to step 51 where a selected salesperson profile is displayed. The user may also return to step 48, and select a new dealer on the map or in the displayed list. Or, the user may return to option 44 and search for another dealer/brand.

If the selected salesperson profile is unsatisfactory or uninteresting to the user, or if the user merely wants to review and compare additional salespeople at the dealership, he or she may return to step 49, step 48 or option 44, and make new selections or searches. However, if the selected salesperson profile is satisfactory or interesting to the potential purchaser, he or she then either contacts the salesperson or requests a price quotation on a particular vehicle, in step 52. Because the potential purchaser will also reach step 52 if option 47 is chosen, that portion of the flow chart will first be discussed, before continuing in explanation of the remainder of the process common to all options.

Option 47 provides for direct access to a “Landing Page”, namely, a particular page within the website of system 12 that contains specific, targeted information for the user. The URL for this Landing Page would typically be advertised in different media, or it may be promoted as a direct link from another Internet website, or it may be discovered as the result of an Internet search. This Landing Page displays, by way of example, a directory of dealers located in a particular state carrying particular brand(s) of motor vehicles. Landing Pages including different targeted information are also contemplated and may readily be implemented.

By browsing this dealer directory, the user is able to select a named dealer. Then, in step 53, the system 12 takes the user to the selected dealer's profile. Again, if the user is not satisfied with his or her selection, a return function will take the user back to the Landing Page for another selection. Otherwise, the user may view the content of the dealer's profile, including the profiles of salespeople who are cross-linked with that dealer. By selecting a particular salesperson, the system 12 displays that person's profile, in step 54. In the event the user is not pleased with his or her selection, or merely wants to view the other salesperson or dealer profiles before proceeding further, the user may select a return function, and revisit either step 53 or option 47. If the user wants to proceed with a particular salesperson shown in a profile, the user proceeds by either contacting the salesperson or requesting a quote from the salesperson, in step 52.

At this juncture, the user may proceed directly to step 56, and make an offline contact with the salesperson. This may be accomplished by the user contacting the salesperson by telephone, Internet chat, video conference or other communications method, or by the user visiting the salesperson at the dealership premises. Using this approach, the user may proceed directly, in step 57, wherein interaction with the selected salesperson takes place, discussing subjects such as vehicle use, likes, dislikes, comparisons with other vehicles, vehicle availability, vehicle ordering, extended warranties, and by making offers, making counter-offers, entering into negotiations, and forming a contract or not making a deal for the purchase of a vehicle.

However, if the user elects to make an electronic contact, through the website of system 12, the user proceeds to step 58, filling in a lead form, providing contact information such as an e-mail address and/or a telephone number. This information is formatted by the system 12 into ADF/XML. ADF is an acronym for Auto-lead Data Format, an XML-based data-exchange standard for the auto industry. It is used by all auto industry CRM (Customer Relation Management) systems. Since all leads are collected and stored in a dealer's CRM database, a dealer can readily manage and track incoming leads. This lead management and tracking would be difficult with leads that are simply based upon incoming e-mails, which are not formatted in XML or other computer language or code that can be parsed and arranged in a dealer's CRM database.

The contact information, and possible request for a quotation, may be reviewed by the dealer before being manually routed to the selected salesperson, in step 59. The system 12 may also be configured for automatic routing in step 59, so that every such lead, requesting a return contact or a price quotation from a user selected salesperson will automatically be routed to that person.

In step 61, the salesperson contacts the potential purchaser, by telephone, e-mail, or other method so that communications regarding the purchase of a vehicle can ensue. The process then moves on to step 57, wherein interaction with the selected salesperson takes place, discussing subjects such as vehicle use, likes, dislikes, comparisons with other vehicles, vehicle availability, vehicle ordering, extended warranties, and by making offers, making counter-offers, entering into negotiations, and forming a contract or not making a deal for the purchase of a vehicle all can take place.

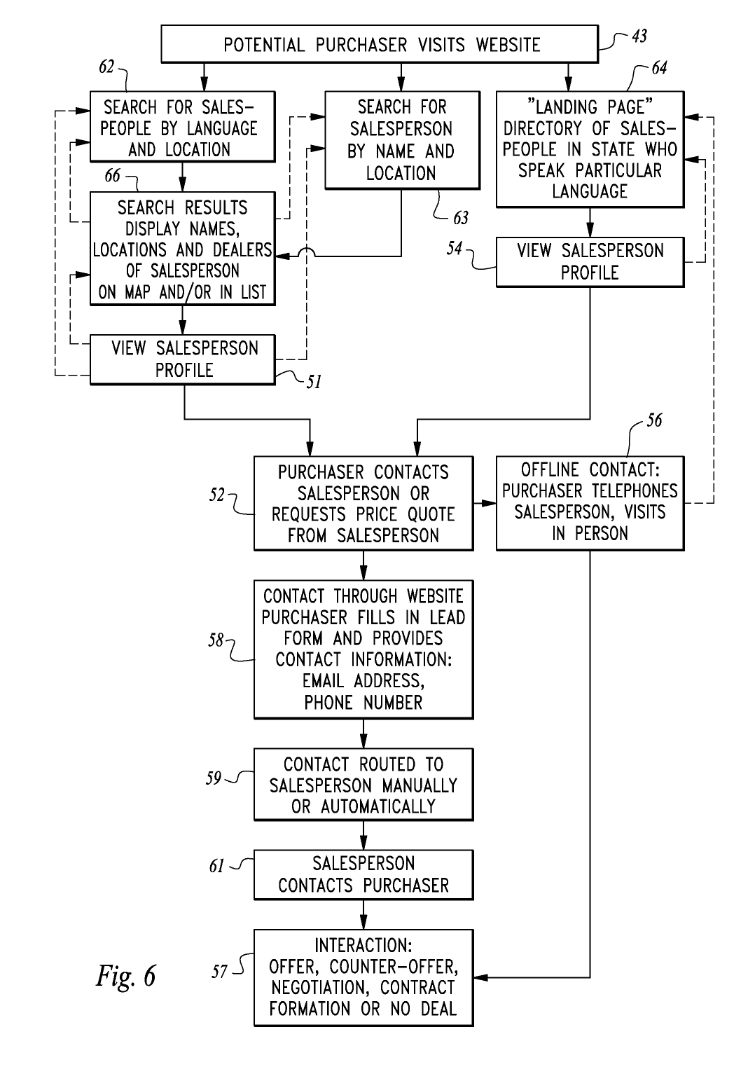

FIG. 6 comprises a flow chart of the steps taken and options presented when a typical search for a salesperson is made. It should be remembered that upon visiting the homepage of the website of system 12, either a search for a dealer or a salesperson may be undertaken. In other words, the flow charts shown in FIGS. 5 and 6 represent alternative and complementary options for the potential purchaser. For the purposes of explanation of FIG. 6, the same numerical identifications will be used, as applicable, for the identical steps previously described for FIG. 5. In addition, no effort will be made to explain all of the return steps and options, shown by broken line in FIG. 6 and explained previously with respect to the flow chart of FIG. 5.

When potential purchaser visits the website 43, three additional options are available, each respecting different kind of a search for a salesperson: Option 62—Search for salespeople by language and location; Option 63—Search for salesperson by name and location; and, Option 64—Directly accessing the “Landing Page” showing a directory of salespeople in a state who speak the selected language.

In the event option 62 is chosen, the user will enter a selected language and a location, typically by city, state, or ZIP code where the sought after salespeople are located. In step 66, the system 12 will display a web page showing the results of the search in which salespeople meeting the language criterion are listed. Additional information displayed includes a map and/or a list of their location(s), and the names of their associated dealers. If option 63 is chosen, namely, search for salesperson by name and location, the user will also be routed to step 66, and will be shown the same information provided in step 66.

The user selects a salesperson from the map and/or list, and in step 51, the system displays a page showing the salesperson profile and any cross-linked profiles of dealers. The user may go to step 52 where he or she then either contacts the salesperson or requests a price quotation on a particular model. Because the potential purchaser will also reach step 52 if option 64 is chosen, that portion of the flow chart will next be discussed, before continuing in explanation of the remainder of the process common to all options.

Option 64 provides for direct access to another “Landing Page”, similar to that described above but containing different content. This Landing Page displays a directory of salespeople located in a particular state who speak a particular language. By browsing this salespeople directory, the user is able to select a named salesperson.

Other Landing Pages, showing different content, are also within the scope of the present system 12. For example, salesperson Landing Pages may display: a directory of salespeople in a geographic area who work in dealership Internet departments; a directory of salespeople with specialized expertise, such as commercial trucks; a directory of salespeople in a geographic area who specialize in working with consumers with sub-prime credit; a directory of salespeople who are fans of a specified sport team; a directory of salespeople with more than 10 years of vehicle sales experience; or, a directory of salespeople who have worked as service technicians.

Then, in step 54, the system 12 takes the user to the selected salesperson's profile. There, the user views the content of the salesperson's profile, including the profiles of any dealers who are cross-linked with that salesperson. In the event the user is not pleased with his or her selection, or merely wants to view the other salesperson profiles before proceeding further, the user may select a return function, and revisit option 64. If the user wants to proceed with a particular salesperson shown in a profile, the user proceeds by either contacting the salesperson or requesting a quote from the salesperson, in step 52.

At this point, the user may proceed directly to step 56, and make an offline contact with the selected salesperson. This may be accomplished by the user contacting the salesperson by telephone, Internet chat, video conference or other communication method, or by the user visiting the salesperson. Using this approach, the user may proceed directly to step 57, initiating direct interaction with the selected salesperson, wherein interaction with the selected salesperson takes place, discussing subjects such as vehicle use, likes, dislikes, comparisons with other vehicles, vehicle availability, vehicle ordering, extended warranties, and by making offers, making counter-offers, entering into negotiations, and forming a contract or not making a deal for the purchase of a motor vehicle.

If the user chooses to make an electronic contact, through the website of system 12, the user proceeds to step 58, filling in a lead form, providing his or her contact information in the form of an e-mail address and/or a telephone number. As discussed previously, this information is formatted by the system 12 into ADF/XML, and collected and stored in the appropriate dealer's CRM database, so that dealer can readily manage and track incoming leads.

The contact information, and possible request for a quotation, may be reviewed by the dealer before being manually routed to the selected salesperson, in step 59. The system 12 may also be configured for automatic routing in step 59, so that every such lead, requesting a return contact or a price quotation from a user selected salesperson will automatically be routed to that person.

In step 61, the salesperson contacts the potential purchaser, either by telephone, e-mail, or other method so that communications regarding the purchase of a vehicle can ensue. The process then moves on to step 57, wherein interaction with the selected salesperson takes place, discussing subjects such as vehicle use, likes, dislikes, comparisons with other vehicles, vehicle availability, vehicle ordering, extended warranties, and by making offers, making counter-offers, entering into negotiations, and forming a contract or not making a deal for the purchase of a motor vehicle.

What is claimed is:

1. A computerized method to facilitate selective communications between and among motor vehicle purchasers, dealers, and salespeople, comprising the steps of:
establishing a profile database including at least one dealer profile and at least one salesperson profile, said dealer profile including textual, or visual, or audio-visual information about a dealer, said salesperson profile including textual, or visual, or audio-visual information about a salesperson, said dealer and said salesperson profiles being cross-linked, so at least some of said information from said dealer profile is displayed on said salesperson profile when said salesperson profile is accessed;
said profile database being under the exclusive control of a dealer/administrator, including edit and manage functions over additions or changes to the content of said dealer profile and said salesperson profile;
said salesperson profile being under the conditional control of a salesperson, including edit and mange functions over additions or changes to the content of said salesperson profile, said edit and manage functions being subordinate to the exclusive control of said dealer/administrator, so that proposed additions or changes to the content of said salesperson profile must be approved or permitted by said dealer/administrator before edit and manage functions for said salesperson profile are enabled;
displaying the content of said at least one dealer profile and said at least one salesman profiles on a publicly accessible electronic business site, so that a potential purchaser can selectively access, review, and compare said profiles of said dealer and said salesperson.

2. A method as in claim 1 in which said textual information in said dealer profile includes contact information, and in which said textual information in said salesperson profile includes contact information.

3. A method as in claim 1 in which said textual information in said salesperson profile includes:
personal interests; personal background; consumer testimonials, and the name, street address, phone number, website links, and motor vehicle brands associated with said dealer.

4. A method as in claim 1 in which said textual information in said dealer's profile includes: name, street address, phone number, website links, and motor vehicle brands associated with said dealer.

5. A method as in claim 1 further including a plurality of profile databases, each said profile database including at least one dealer profile and at least one salesperson profile, each said profile database being under the exclusive control of a respective dealer/administrator and each said salesperson profile being under the conditional control of a respective salesperson.

6. A method as in claim 1 including at least two dealer profiles associated with dealers under common ownership or control, in which said at least one salesperson profile is cross-linked with each of said dealer profiles.

7. A method as in claim 1 including a plurality of salesperson profiles, associated with said salesperson, each of said salesperson profiles being cross-linked with said dealer profile, each of said salesperson profiles containing different textual information, or visual information, or audio-visual information about said salesperson.

8. A method as in claim 7 in which said salesperson profiles include textual information in different languages and in which said audio-visual information includes videos having audio tracks in different languages.

9. A method as in claim 1 in which said proposed edits and changes are sent by said salesperson to said dealer/administrator, and if approved, said dealer/administrator enables said edit and manage function so said proposed edits and changes will be included in said salesperson profile.

10. A method as in claim 1 including at least two dealer profiles, in which a single said dealer/administrator is in exclusive control of said at least two dealer profiles.

11. A computerized method to facilitate selective communications between and among motor vehicle purchasers, dealers, and salespeople, comprising the steps of:
providing an electronic business site on a public network , said electronic business site displaying at least one dealer profile and at least one salesperson profile, said dealer profile including textual, or visual, or audio-visual information about a dealer, said salesperson profile including textual, or visual, or audio-visual information about a salesperson, said dealer and said salesperson profiles being cross-linked, so at least some of said information from said dealer profile is displayed on said salesperson profile when said salesperson profile is accessed;
said dealer profile and said salesperson profile being under the exclusive control of a dealer/administrator, including edit and manage functions over additions or changes to the content of said dealer profile and said salesperson profile;
said salesperson profile being under the conditional control of a salesperson, including edit and mange functions over additions or changes to the content of said salesperson profile, said edit and manage functions being subordinate to the exclusive control of said dealer/administrator, so that proposed additions or changes to the content of said salesperson profile must be approved or permitted by said dealer/administrator before edit and manage functions for said salesperson profile are enabled;
said textual and/or visual information about said dealer and said textual and/or visual information about said salesperson including at least one telephone number or at least one e-mail address associated with said dealer and said salesperson, so that a potential purchaser can selectively access, review, and compare said profiles of said dealer and said salesperson and be able to contact either said dealer or said salesperson by telephone or over an electronic network.

12. A method as in claim 11 in which said textual information in said salesperson profile includes:
personal interests; personal background; customer testimonials, and the name, street address, phone number, website links, and motor vehicle brands associated with said dealer.

13. A method as in claim 11 in which said textual information in said dealer's profile further includes: name, street address, website links, and motor vehicle brands associated with said dealer.

14. A method as in claim 11 further including a plurality of dealer profiles and a plurality of salesperson profiles, each said dealer profile being under the exclusive control of a respective dealer/administrator and each said salesperson profile being under the conditional control of a respective salesperson.

15. A method as in claim 11 including at least two dealer profiles associated with dealers under common ownership or control, in which said at least one salesperson profile is cross-linked with each of said dealer profiles.

16. A method as in claim 11 including a plurality of salesperson profiles associated with said salesperson, each of said salesperson profiles being cross-linked with said dealer profile, each of said salesperson profiles containing different textual, or visual, or audio-visual information about said salesperson.

17. A method as in claim 16 in which said salesperson profiles include textual information in different languages and in which said audio-visual information includes videos having audio tracks in different languages.

18. A method as in claim 11 in which said proposed edits and changes are sent by said salesperson to said dealer/administrator, and if approved, said dealer/administrator enables said edit and manage function so said proposed edits and changes will be included in said salesperson profile.

19. A method as in claim 11 including at least two dealer profiles, in which a single said dealer/administrator is in exclusive control of said at least two dealer profiles.

20. A computerized method to facilitate selective communications between and among motor vehicle purchasers, dealers, and salespeople, comprising the steps of:
providing an electronic business site on a public network , said electronic business site displaying at least one dealer profile and at least one salesperson profile, said dealer profile including textual, or visual, or audio-visual information about a dealer, said salesperson profile including textual, or visual, or audio-visual information about a salesperson, said dealer and said salesperson profiles being cross-linked, so at least some of said information from said dealer profile is displayed on said salesperson profile when said salesperson profile is accessed by a potential purchaser;
said dealer profile and said salesperson profile being under the exclusive control of a dealer/administrator, including edit and manage functions over additions or changes to the content of said dealer profile and said salesperson profile;
said salesperson profile being under the conditional control of a salesperson, including edit and mange functions over additions or changes to the content of said salesperson profile, said edit and manage functions being subordinate to the exclusive control of said dealer/administrator, so that proposed additions or changes to the content of said salesperson profile must be approved or permitted by said dealer/administrator before edit and manage functions for said salesperson profile are enabled;
said textual and/or visual information about said dealer and said textual and/or visual information about said salesperson including at least one telephone number or at least one e-mail address associated with said dealer and said salesperson, so that a potential purchaser can selectively access, review, and compare said profiles of said dealer and said salesperson and be able to contact either said dealer or said salesperson by telephone or e-mail; and,
receiving payment from said dealer, said payment being based either upon the service of displaying said dealer profile and said salesperson profile, or upon the number of leads developed when a potential purchaser contacts either said dealer or said salesperson.
